(19) United States
(12) Patent Application Publication
(10) Pub. No.: US 2019/0195231 A1
(43) Pub. Date: Jun. 27, 2019

(54) CENTRIFUGAL FAN

(71) Applicant: Nidec Corporation, Kyoto (JP)

(72) Inventors: Kiyoto IDA, Kyoto (JP); Masashi HIRAYAMA, Kyoto (JP); Takehito TAMAOKA, Kyoto (JP)

(21) Appl. No.: 16/203,701

(22) Filed: Nov. 29, 2018

(30) Foreign Application Priority Data
Dec. 26, 2017 (JP) 2017-250040

(51) Int. Cl. F04D 17/16; F04D 29/26; F04D 29/28; F04D 25/06

(52) U.S. Cl. CPC F04D 17/16; F04D 29/263; F05B 2260/302; F04D 25/0606; F05B 2240/301; F04D 29/281

(57) ABSTRACT

A centrifugal fan includes a motor, an impeller, and a housing. The motor includes a rotary portion that rotates about a vertical center axis. The impeller is fixed to and rotates together with the rotary portion. The housing accommodates the motor and impeller. The rotary portion includes a rotor holder with a magnet. The impeller includes circumferentially disposed blades and a blade support. The blade support supports the blades on an outer side. The housing includes an inlet port axially penetrating an upper surface and an outlet port radially penetrating a side surface. At least a portion of an inner surface of the blade support radially faces an outer surface of the rotor holder with a gap therebetween containing adhesive at least partially. At least one of the outer surface of the rotor holder and the inner surface of the blade support includes a radially recessed portion containing adhesive.

### CROSS REFERENCE TO RELATED APPLICATIONS

This application claims the benefit of priority to Japanese Patent Application No. 2017-250040 filed on Dec. 26, 2017. The entire contents of this application are hereby incorporated herein by reference.

### BACKGROUND OF THE INVENTION

### 1. Field of the Invention

The present disclosure relates to a centrifugal fan.

### 2. Description of the Related Art

A motor fan disclosed in Japanese Unexamined Patent Application Publication No. 2006-105013 includes a casing, a rotary machine and a control circuit thereof, and an impeller blade wheel. The casing forms a ventilation path. The rotary machine and the control circuit thereof are mounted in the casing. The impeller blade wheel is held together with a rotary permanent magnet of the rotary machine by a rotary hub fixed to a rotary shaft so as to be rotatable, and is disposed in the ventilation path of the casing. The rotary hub is composed of a good heat conductor such as a metal. The rotary hub has a head portion having an arcuate cross section, a plurality of recessed portions extending in an axial direction on a cylinder portion outer circumferential surface communicating with the head portion, and leg portions extending in the axial direction from a fitting holding cylinder portion end edge of the impeller blade wheel and corresponding to and fitting in the recessed portions, the impeller blade wheel being fixed by the fitting of the recessed portions and the leg portions.

In a thin centrifugal fan, the thickness of the rotary hub in the axial direction is small and it is difficult to secure sufficient space for fixing the impeller blade wheel. In the case where a fixing portion between the impeller blade wheel and the rotary hub is elongated in the axial direction, an inlet space of an inlet port is narrowed and a blowing amount is reduced. In addition, in the case where press-fit fixing is performed for the purpose of firmly fixing the impeller blade wheel and the rotary hub without increasing the axial-direction length of the fixing portion, there is a possibility that the impeller blade wheel and the rotary hub may deform.

### SUMMARY OF THE INVENTION

A centrifugal fan according to an exemplary embodiment of the present invention includes a motor, an impeller, and a housing. The motor includes a rotary portion that rotates about a center axis extending up and down. The impeller is fixed to the rotary portion and rotates together with the rotary portion. The housing accommodates the motor and the impeller. The rotary portion includes a rotor holder in which a magnet is fixed. The impeller includes a plurality of blade portions and a blade support portion. The plurality of blade portions are disposed at intervals in a circumferential direction. The blade support portion supports the plurality of blade portions on a radial-direction outer side. The housing includes an inlet port and an outlet port. The inlet port is provided on an upper surface of the housing and penetrates the housing in an axial direction. The outlet port is provided on a side surface of the housing and penetrates the housing in a radial direction. At least a portion of an inner circumferential surface of the blade support portion faces an outer circumferential surface of the rotor holder in the radial direction with a gap therebetween in which an adhesive agent is present at least in a portion of the gap. At least one of the outer circumferential surface of the rotor holder and the inner circumferential surface of the blade support portion includes a recessed portion that is recessed in the radial direction and in which the adhesive agent is present.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating a configuration of a centrifugal fan according to an exemplary embodiment of the present invention.

FIG. 2 is a vertical sectional view of a centrifugal fan according to an embodiment exemplary of the present invention.

FIG. 3 is a vertical sectional view of a rotor holder.

FIG. 4 is a perspective view of an impeller.

FIG. 5 is an enlarged view illustrating a portion of FIG. 2 in an enlarged manner.

FIG. 6 is a view for explaining a preferred arrangement of an accommodating portion and a balance adjustment member.

FIG. 7 is a schematic plan view illustrating a portion of a fixing structure of the impeller that fixes the impeller to the rotor holder.

FIG. 8 is a schematic sectional view taken along the line A-A in FIG. 7.

FIG. 9 is a schematic sectional view illustrating a modification example of the fixing structure of the impeller.

### DETAILED DESCRIPTION OF THE PREFERRED EMBODIMENTS

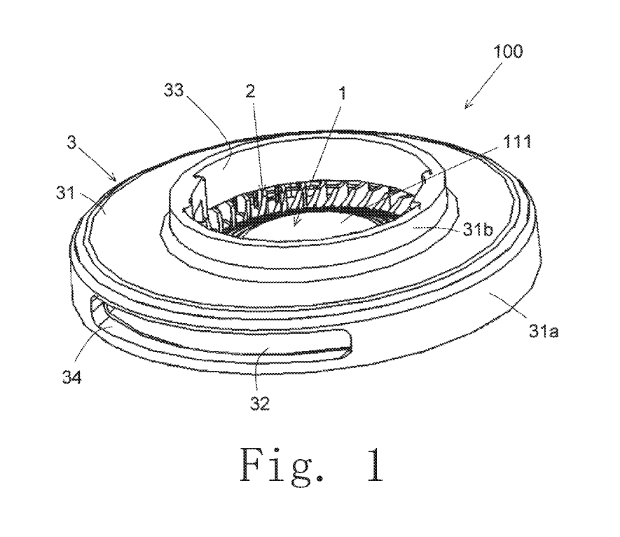

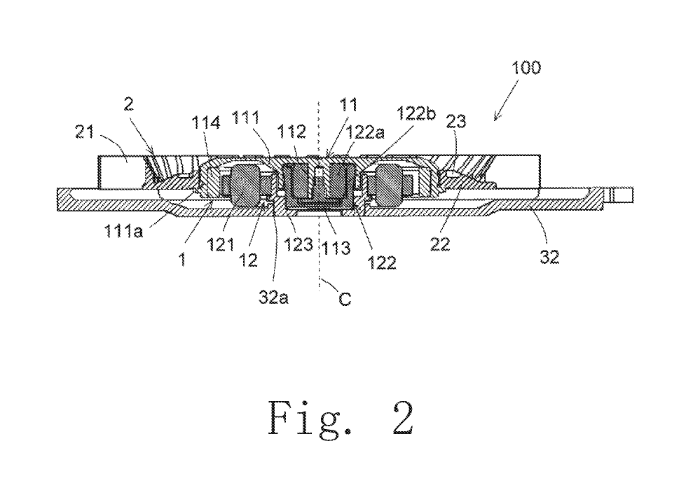

Hereinafter, exemplary embodiments of the present invention will be described in detail with reference to the drawings. Further, in this specification, a direction parallel to a center axis C of a motor 1 included in a centrifugal fan 100 illustrated in FIG. 2 will be referred to as “axial direction”, a direction perpendicular to the center axis C will be referred to as “radial direction”, and a direction along an arc about the center axis C will be referred to as “circumferential direction”. In addition, in the present specification, the shape and positional relationship of each element will be described with the axial direction taken as the up-down direction and with a side provided with an inlet port 33 illustrated in FIG. 1 as an upper side with respect to the motor 1. However, in practicality, there is no intention to limit the orientation of the centrifugal fan 100 according to the present invention to this up-down direction definition.

FIG. 1 is a perspective view illustrating a configuration of the centrifugal fan 100 according to an embodiment of the present invention. FIG. 2 is a vertical sectional view of the centrifugal fan 100 according to the embodiment of the present invention. As illustrated in FIG. 1 and FIG. 2, the centrifugal fan 100 includes the motor 1, an impeller 2, and a housing 3. Further, the housing 3 includes, in detail, an upper housing 31 and a lower housing 32. FIG. 2 illustrates the centrifugal fan 100 from which the upper housing 31 has been removed.

The motor 1 is of an outer rotor type. The motor 1 includes a rotary portion 11. The motor 1 further includes a stationary portion 12.

The rotary portion 11 rotates about the center axis C extending in the up-down direction. The rotary portion 11 includes a rotor holder 111. The rotary portion 11 further includes a shaft 112, a thrust plate 113, and a magnet 114. The shaft 112 is disposed centered on the center axis C.

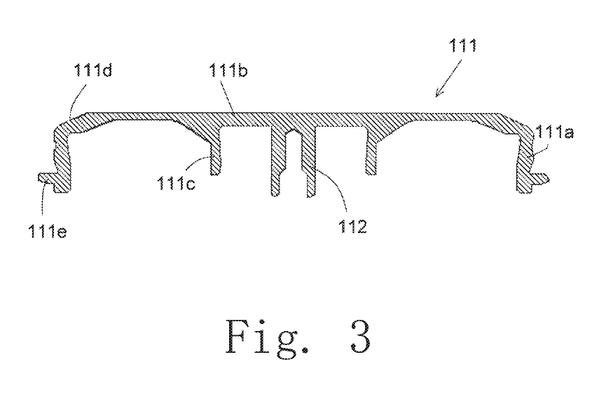

FIG. 3 is a vertical sectional view of the rotor holder 111. As illustrated in FIG. 2 and FIG. 3, the rotor holder 111 is a capped cylindrical member centered on the center axis C. The magnet 114 is fixed in the rotor holder 111. Specifically, the rotor holder 111 includes a rotor cylinder portion 111a. The rotor cylinder portion 111a has a cylindrical shape. The magnet 114 is fixed to an inner circumferential surface of the rotor cylinder portion 111a. The magnet 114 is fixed to the inner circumferential surface of the rotor cylinder portion 111a by, for example, an adhesive agent. The rotor holder 111 further includes a rotor lid portion 111b. The rotor lid portion 111b is located on the upper side of the rotor cylinder portion 111a and is connected to the rotor cylinder portion 111a. The rotor lid portion 111b extends to a radial-direction outer side from an upper end portion of the shaft 112. The rotor lid portion 111b has, on a lower surface thereof, a rotor annular portion 111c surrounding the shaft 112.

Further, the configuration of the rotor holder 111 is not limited to this, and, for example, the rotor cylinder portion 111a may be a separate member disposed on the radial-direction outer side of the rotor lid portion 111b. In this case, the rotor cylinder portion 111a is fixed to the impeller 2 by insert molding. In other words, the rotor cylinder portion 111a is disposed on the radial-direction outer side of a radial-direction outer end of the rotor lid portion 111b with a gap therebetween.

Further, in the present embodiment, the rotor holder 111 and the shaft 112 are a single member. For example, the rotor holder 111 and the shaft 112 are formed by cutting a metal member. However, the shaft 112 may be a separate member from the rotor holder 111. In this case, the upper end portion of the shaft 112 is fixed to the rotor lid portion 111b.

The thrust plate 113 is a disk-like member extending in the radial direction. The thrust plate 113 is formed of, for example, a metal. The thrust plate 113 is fixed to a lower end portion of the shaft 112. An upper surface of the thrust plate 113 faces a lower surface of a sleeve 122a (described later) in the axial direction. The thrust plate 113 may be a single member with the shaft 112.

The magnet 114 fixed to the inner circumferential surface of the rotor cylinder portion 111a has an annular shape. However, the magnet 114 may be composed of a plurality of magnet pieces disposed at intervals in the circumferential direction.

The stationary portion 12 includes a stator 121, a bearing portion 122, and a bush 123.

The stator 121 is an annular member centered on the center axis C. The stator 121 is disposed on a radial-direction inner side of the magnet 114. The stator 121 is an armature that generates a magnetic flux according to a drive current. The stator 121 includes a stator core, an insulator, and coils. The stator core is a magnetic body. The stator core is, for example, formed by laminating electromagnetic steel plates. The stator core has an annular core back and a plurality of teeth. An inner circumferential surface of the core back is fixed to an outer circumferential surface of the bush 123. The plurality of teeth protrude to the radial-direction outer side from the core back. The insulator is an insulating body. As a material of the insulator, for example, a resin may be used. The insulator covers at least a portion of the stator core. The coils are formed by winding a conductive wire around the teeth with the insulator therebetween.

The bearing portion 122 is disposed on the radial-direction inner side of the stator 121. The bearing portion 122 includes the sleeve 122a and a sleeve housing 122b. The sleeve 122a has a cylindrical shape centered on the center axis C. The sleeve 122a is, for example, a metal sintered body and is impregnated with a lubricating oil. The sleeve housing 122b has a housing cylinder portion and a housing cap. The sleeve housing 122b is formed of, for example, a metal. The housing cylinder portion has a cylindrical shape centered on the center axis C. The sleeve 122a is fixed to an inner circumferential surface of the housing cylinder portion. The housing cap is fixed to a lower end portion of the housing cylinder portion. The housing cap closes a lower portion of the housing cylinder portion.

The shaft 112 passes through the sleeve 122a and is located on the radial-direction inner side of the sleeve 122a. A gap where the lubricating oil is present is formed between an outer circumferential surface of the shaft 112 and an inner circumferential surface of the sleeve 122a in the radial direction. A gap where the lubricating oil is present is formed between a lower surface of the thrust plate 113 and an upper surface of the housing cap of the sleeve housing 122b in the axial direction.

The bush 123 is a cylindrical member. The bush 123 is formed by, for example, cutting a metal member. An inner circumferential surface of the bush 123 is fixed to a lower region of an outer circumferential surface of the sleeve housing 122b. The bush 123 is inserted and fixed in a lower housing hole portion 32a provided in the lower housing 32 and penetrating in the axial direction.

By supplying a driving current to the stator 121, a rotational torque is generated between the magnet 114 and the stator 121. As a result, the rotor holder 111 rotates with respect to the stator 121, and the impeller 2 fixed to the rotor holder 111 also rotates about the center axis C.

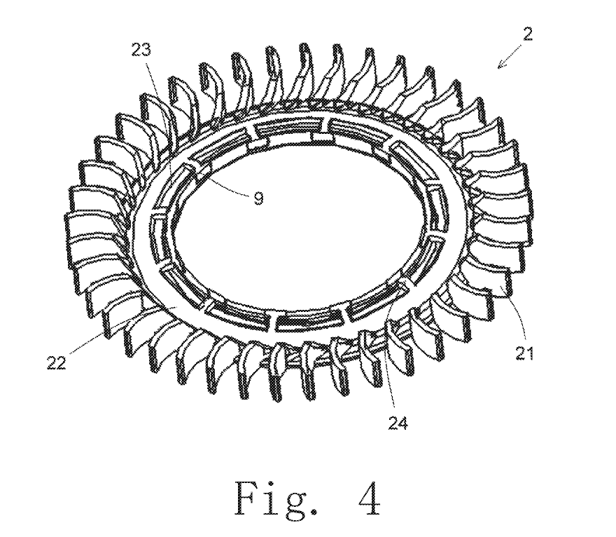

FIG. 4 is a perspective view of the impeller 2. FIG. 4 is a view of the impeller 2 as seen diagonally from above. The impeller 2 is fixed to the rotary portion 11 and rotates together with the rotary portion 11. More specifically, as illustrated in FIG. 2, the impeller 2 is fixed to the rotor holder 111. The impeller 2 is located on the radial-direction outer side of the rotor holder 111. The impeller 2 is formed of a resin. However, the impeller 2 may be formed of another member such as a metal.

As illustrated in FIG. 2 and FIG. 4, in detail, the impeller 2 has a plurality of blade portions 21 and a blade support portion 22. The plurality of blade portions 21 and the blade support portion 22 are a single member. The plurality of blade portions 21 are disposed at intervals in the circumferential direction. In detail, the plurality of blade portions 21 are disposed at equal intervals in the circumferential direction about the center axis C. The shapes of the plurality of blade portions are the same. The blade support portion 22 supports the plurality of blade portions 21 on the radial-direction outer side. The blade support portion 22 is provided in an annular shape. Specifically, the blade support portion 22 has an annular shape centered on the center axis C. At least a portion of the blade support portion 22 is located on the radial-direction outer side of the rotor holder 111. In the present embodiment, the blade support portion 22 is located on the radial-direction outer side of the rotor cylinder portion 111a and is fixed to the rotor holder 111. In the present embodiment, the blade support portion 22 is fixed to the rotor holder 111 by using an adhesive agent. Each of the blade portions 21 extends to the radial-direction outer side from a radial-direction outer end of the blade support portion 22. Each of the blade portions 21 extends to the radial-direction outer side while curving. In the present embodiment, a lower surface of the blade portions 21 and a lower surface of the blade support portion 22 are located on the same plane. Further, note that the lower surface of the blade portions 21 may be located on the upper side or lower side of the lower surface of the blade support portion 22.

The housing 3 accommodates the motor 1 and the impeller 2. The housing 3 is formed of, for example, a resin or a metal. The upper housing 31 and the lower housing 32 may be formed of the same material or may be formed of different materials. The upper housing 31 has a cylindrical shape centered on the center axis C. Specifically, the upper housing 31 has a first cylinder portion 31a and a second cylinder portion 31b having different outer diameters. The second cylinder portion 31b having a small diameter is disposed on the first cylinder portion 31a having a large diameter, and both the first cylinder portion 31a and the second cylinder portion 31b are formed as a single connected member. The lower housing 32 is in the form of a flat plate extending in the radial direction from the center axis C. The stationary portion 12 of the motor 1 is fixed to the lower housing 32. The stator 121 is disposed on an upper surface of the lower housing 32.

The housing 3 has the inlet port 33 and an outlet port 34. The inlet port 33 is provided on an upper surface of the housing and penetrates the housing in the axial direction. The outlet port 34 is provided on a side surface of the housing and penetrates the housing in the radial direction. In the present embodiment, an upper end opening of the second cylinder portion 31b forms the inlet port 33. The inlet port 33 has a circular shape. The outlet port 34 penetrates the first cylinder portion 31a in the radial direction. The outlet port 34 extends in the circumferential direction and has a rectangular shape in plan view from the radial direction. Further, the shapes of the inlet port 33 and the outlet port 34 are not limited to these. For example, the upper housing 31 need not have the second cylinder portion 31b, and an upper end opening of the first cylinder portion 31a may form the inlet port 33. In addition, the outlet port 34 may be formed by providing a gap between the upper housing 31 and the lower housing 32 in the axial direction. Furthermore, a cylinder portion extending to an axial-direction upper side may be formed in the lower housing 32, and the outlet port 34 may be formed by penetrating the cylinder portion in the radial direction.

By the rotation of the impeller 2, air is sucked into the housing 3 from the inlet port 33. The air sucked into the housing 3 is swirled in the housing 3 in the circumferential direction by the rotation of the impeller 2 and then discharged from the outlet port 34.

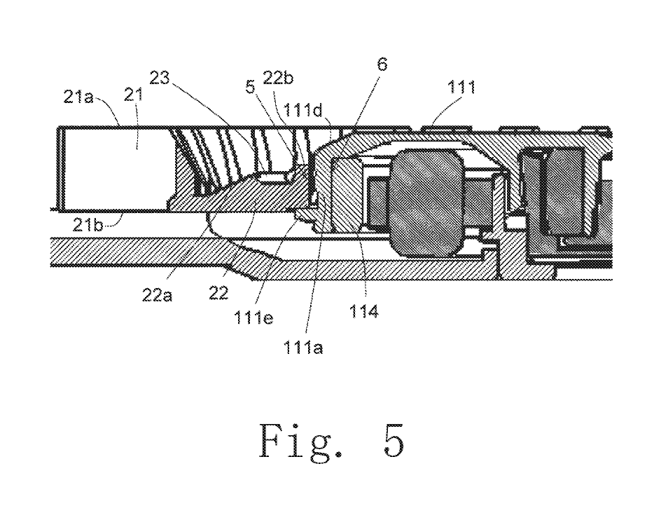

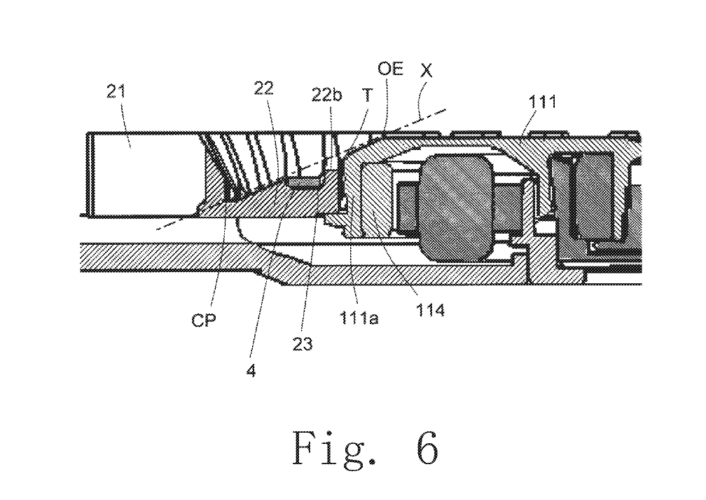

Next, a balance adjustment structure of the impeller 2 included in the centrifugal fan 100 will be described. FIG. 5 is an enlarged view illustrating a portion of FIG. 2 in an enlarged manner. As illustrated in FIG. 2, FIG. 4 and FIG. 5, the blade support portion 22 has an accommodating portion 23 that accommodates a balance adjustment member 4 (see FIG. 6 described later). The balance adjustment member 4 is a member disposed for adjusting the rotational balance of the impeller 2. In the case where it is necessary to adjust the rotational balance of the impeller 2, the balance adjustment member 4 is disposed at a place where balance adjustment of the accommodating portion 23 is required. The balance adjustment member 4 is not disposed in a place where it is not necessary to adjust the rotational balance of the impeller 2. Further, in the case where the adjustment of the rotational balance of the impeller 2 is not required at all, the balance adjustment member 4 is not disposed in the accommodating portion 23. The balance adjustment member 4 is, for example, an adhesive agent or a solid weight or the like.

The accommodating portion 23 is disposed on the radial-direction inner side of the blade portions 21 and between an upper end 21a and a lower end 21b of the blade portions 21 in the axial direction. In the present embodiment, an upper surface and a lower surface of the blade portions 21 are flat. Therefore, the upper surface of the blade portions 21 is the upper end 21a of the blade portions 21 and the lower surface of the blade portions 21 is the lower end 21b of the blade portions 21. However, at least one of the upper surface and the lower surface of the blade portions 21 may be a curved surface such as a projecting surface or a recessed surface. In the case of such a curved surface, the upper end 21a of the blade portions 21 is a portion of the upper surface of the blade portions 21, and the lower end 21b of the blade portions 21 is a portion of the lower surface of the blade portions 21. In other words, the accommodating portion 23 is disposed within the maximum axial-direction length of the blade portions 21.

In the present embodiment, the accommodating portion 23 is provided between the upper end 21a and the lower end 21b of the blade portions 21 without providing an accommodating portion for accommodating the balance adjustment member 4 in the upper portion and lower portion of the blade portions 21. As a result, the impeller 2 can be made thinner. In addition, according to the present embodiment, it is not necessary to dispose the balance adjustment member 4 separately for the upper portion and lower portion of the blade portions 21 and the load of the balance adjustment work can be reduced. Further, more preferably, the accommodating portion 23 is disposed in the middle between the upper end 21a and the lower end 21b of the blade portions 21 in the axial direction. As a result, it is possible to adjust the balance of the impeller 2 without offsetting the blade portions 21 vertically.

In the present embodiment, the accommodating portion 23 opens upward. More specifically, the accommodating portion 23 is a groove portion that is on an upper surface of the blade support portion 22 and that is recessed to an axial-direction lower side. According to this, because the accommodating portion 23 has a bottom surface, it is possible to easily dispose the balance adjustment member 4 in the accommodating portion 23. In addition, in the case where a member having fluidity such as an adhesive agent is used as the balance adjustment member 4, it is possible to suppress the balance adjustment member 4 from flowing out downward from the accommodating portion 23 during operation. Further, the shape of the accommodating portion 23 is not particularly limited. The accommodating portion 23 may have, for example, a U shape, a V shape, or the like when viewed in vertical section.

The accommodating portion 23 extends in the circumferential direction. In the present embodiment, the accommodating portion 23 is provided annularly about the center axis C. Specifically, the accommodating portion 23 has an annular shape. However, a plurality of accommodating portions 23 may be disposed at intervals in the circumferential direction. As illustrated in FIG. 4, a plurality of ribs 24 extending in a direction including a radial-direction component are disposed inside the accommodating portion 23, which is annular. In the present embodiment, the plurality of ribs 24 are disposed at equal intervals in the circumferential direction. Each of the ribs 24 extends in the radial direction. However, each of the ribs 24 may extend diagonal to the radial direction. Although it is preferable that the plurality of ribs 24 and the blade support portion 22 be a single member, the plurality of ribs 24 may be separate members from the blade support portion 22. The rigidity of the impeller 2 can be improved by providing the plurality of ribs 24 in the accommodating portion 23. Therefore, it is possible to make the impeller 2 thin.

Further, the accommodating portion 23 may be a through hole penetrating in the axial direction. In this case, it is preferable that a plurality of accommodating portions 23 be disposed at intervals in the circumferential direction. The plurality of through holes may have an arcuate shape, a circular shape, or the like. The through holes forming the accommodating portions 23 may be configured such that an opening diameter on the lower side is smaller than that on the upper side. According to this configuration, it is possible to suppress the adhesive agent from flowing out downward until the adhesive agent is cured by the action of the surface tension in the through holes. In addition, the accommodating portion 23 may be a groove portion on the lower surface of the blade support portion 22 that is recessed to the axial-direction upper side.

The accommodating portion 23 overlaps in the radial direction at least a portion of an impeller fixing portion 5 in which an inner circumferential surface of the blade support portion 22 and an outer circumferential surface of the rotor holder 111 are fixed. More specifically, the accommodating portion 23 overlaps in the radial direction at least a portion of the impeller fixing portion 5 in which the inner circumferential surface of the blade support portion 22 and an outer circumferential surface of the rotor cylinder portion 111a are fixed. In the present embodiment, the impeller fixing portion 5 has a configuration in which the inner circumferential surface of the blade support portion 22 and the outer circumferential surface of the rotor cylinder portion 111a are fixed with an adhesive agent. The accommodating portion 23 is located on the radial-direction outer side of the impeller fixing portion 5. In the impeller fixing portion 5, an imbalance tends to occur, for example, due to variations in the amount of adhesive agent used for fixing and variations in component dimensions. According to this configuration, the accommodating portion 23 that accommodates the balance adjustment member 4 is provided at a position overlapping at least a portion of the impeller fixing portion 5 in the radial direction. As a result, it is possible to perform balance adjustment near the position at which an imbalance occurs and it is possible to improve the accuracy of balance adjustment. Further, in the present embodiment, the accommodating portion 23 overlaps a portion of the impeller fixing portion 5 in the radial direction. According to this, the accommodating portion 23 does not become overly large and it is possible to suppress a decrease in the strength of the blade support portion 22.

Further, in the case where the rotor cylinder portion 111a is a separate member disposed on the radial-direction outer side of the rotor lid portion 111b, the inner circumferential surface of the blade support portion 22 is fixed to an outer circumferential surface of the rotor lid portion 111b or an outer circumferential surface of the rotor annular portion 111c. At this time, the impeller fixing portion 5 is formed such that the inner circumferential surface of the blade support portion 22 and the outer circumferential surface of the rotor lid portion 111b or the outer circumferential surface of the rotor annular portion 111c are fixed with an adhesive agent. The accommodating portion 23 is located on the radial-direction outer side of the impeller fixing portion 5.

The accommodating portion 23 overlaps in the radial direction at least a portion of a magnet fixing portion 6 in which the inner circumferential surface of the rotor cylinder portion 111a and an outer circumferential surface of the magnet 114 are fixed. The accommodating portion 23 is located on the radial-direction outer side of the magnet fixing portion 6. In the magnet fixing portion 6, for example, an imbalance tends to occur due to variations in the amount of adhesive agent used for fixing and variations in component dimensions. According to this configuration, the accommodating portion 23 that accommodates the balance adjustment member 4 is provided at a position overlapping at least a portion of the magnet fixing portion 6 in the radial direction. For this reason, it is possible to perform balance adjustment near the position at which an imbalance occurs and it is possible to improve the accuracy of balance adjustment. Further, in the present embodiment, the accommodating portion 23 overlaps a portion of the magnet fixing portion 6 in the radial direction. According to this, the accommodating portion 23 does not become overly large, and it is possible to suppress a decrease in the strength of the blade support portion 22.

As a preferred embodiment, as illustrated in FIG. 5, the blade support portion 22 has a first inclined surface 22a that has an axial-direction height that increases from the radial-direction outer side to the radial-direction inner side. The first inclined surface 22a may be a flat surface or a curved surface such as a projecting surface or a recessed surface. According to this, it is possible to make the air introduced from the inlet port 33 smoothly flow toward the blade portions 21 by the first inclined surface 22a. The accommodating portion 23 is located on the radial-direction inner side of the first inclined surface 22a. In the present embodiment, the accommodating portion 23 is adjacent to the first inclined surface 22a. The accommodating portion 23 is located on the radial-direction inner side of the first inclined surface 22a. Therefore, it is possible to suppress the flow of air along the first inclined surface 22a from being hindered by the accommodating portion 23. That is, according to the present configuration, it is possible to efficiently send the air introduced from the inlet port 33 to the outlet port 34.

In a preferred form, as illustrated in FIG. 5, the rotor holder 111 has a second inclined surface 111d that has an axial-direction height that increases from the radial-direction outer side toward the radial-direction inner side at an end portion of an upper portion of the rotor holder 111 on the radial-direction outer side. The second inclined surface 111d is located on the axial-direction upper side of an upper end of the blade support portion 22. In the present embodiment, the blade support portion has a flat portion 22b parallel to a horizontal plane perpendicular to the axial direction on the radial-direction inner side of the accommodating portion 23. The flat portion 22b corresponds to the upper end of the blade support portion 22. The second inclined surface 111d may be a flat surface or a curved surface such as a projecting surface or a recessed surface.

By providing the second inclined surface 111d, it is possible to widen the flow path of the air flowing into the housing 3 from the inlet port 33. Because the second inclined surface 111d is located on the upper side of the upper end of the blade support portion 22, it is possible to suppress the flow of air passing through the second inclined surface 111d toward the blade portions 21 from being hindered by the blade support portion 22.

FIG. 6 is a view for explaining a preferable arrangement of the accommodating portion 23 and the balance adjustment member 4. In a preferred form, as illustrated in FIG. 6, the accommodating portion 23 is located below an upper end T of the outer circumferential surface of the rotor holder 111.

Specifically, the accommodating portion 23 is located below an upper end T of the outer circumferential surface of the rotor cylinder portion 111a. As a result, it is possible to suppress the flow of the air flowing in through the inlet port 33 from being hindered by the accommodating portion 23 and to efficiently send the air to the outlet port 34.

As a more preferable form, as illustrated in FIG. 6, the accommodating portion 23 is located on the lower side of a straight line X connecting a connection point CP of the upper surface of the blade support portion 22 and an end portion of the blade portions 21 on the radial-direction inner side and a radial-direction outer end OE of an upper end portion of the rotor holder 111. That is, the groove portion is located on the lower side of a straight line X connecting the connection point CP of the upper surface of the blade support portion 22 and the end portion of the blade portions 21 on the radial-direction inner side and the radial-direction outer end OE of the upper end portion of the rotor holder 111. According to this, because the height position of the accommodating portion 23 can be set to be low, it is possible to suppress the accommodating portion 23 from obstructing the flow of the air flowing from the inlet port 33. Further, in the case where the second inclined surface 111d is not provided and the rotor holder 111 has a corner portion at an upper portion outer circumferential end, the radial-direction outer end OE of the upper end portion of the rotor holder 111 coincides with the upper end T of the outer circumferential surface of the rotor cylinder portion 111a. In addition, similarly, in the case where the rotor holder 111 has an R shape at the upper portion outer circumferential end, the radial outer end OE of the upper end portion of the rotor holder 111 coincides with the upper end T of the outer circumferential surface of the rotor cylinder portion 111a.

As illustrated in FIG. 6, an upper end of the inner circumferential surface of the blade support portion 22 is preferably located on the lower side of the straight line X connecting the connection point CP of the upper surface of the blade support portion 22 and the end portion of the blade portions on the radial-direction inner side and the radial-direction outer end OE of the upper end portion of the rotor holder 111. As a result, it is possible to suppress the flow of the air flowing in through the inlet port 33 from being obstructed by the inner circumferential surface of the blade support portion 22 and to efficiently send the air to the outlet port 34. In the present embodiment, a radial-direction inner end of the flat portion 22b located on the radial-direction inner side of the accommodating portion 23 forms the upper end of the inner circumferential surface of the blade support portion 22.

It is preferable that the balance adjustment member 4 be accommodated without extending out from the accommodating portion 23 to the upper side. However, the balance adjustment member 4 may project to the upper side from the accommodating portion 23. In consideration of this point, it is preferable that an upper end of the balance adjustment member 4 accommodated in the accommodating portion 23 be located below the upper end of the outer circumferential surface of the rotor holder 111. Specifically, as illustrated in FIG. 6, the upper end of the balance adjustment member 4 accommodated in the accommodating portion 23 is preferably located below the upper end T of the outer circumferential surface of the rotor cylinder portion 111a. As a result, it is possible to suppress the flow of the air flowing in through the inlet port 33 from being obstructed by the balance adjustment member 4 and to efficiently send the air to the outlet port 34.

As illustrated in FIG. 6, the upper end of the balance adjustment member 4 accommodated in the accommodating portion 23 is preferably located on the lower side of the straight line X connecting the connection point CP of the upper surface of the blade support portion 22 and the end portion of the blade portions on the radial-direction inner side and the radial-direction outer end OE of the upper end portion of the rotor holder 111. According to this, because the height position of the balance adjustment member 4 can be set to be low, it is possible to suppress the balance adjustment member 4 from obstructing the flow of the air flowing from the inlet port 33.

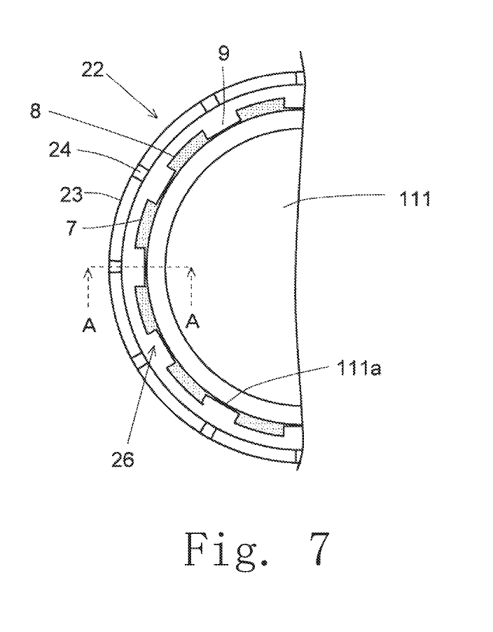

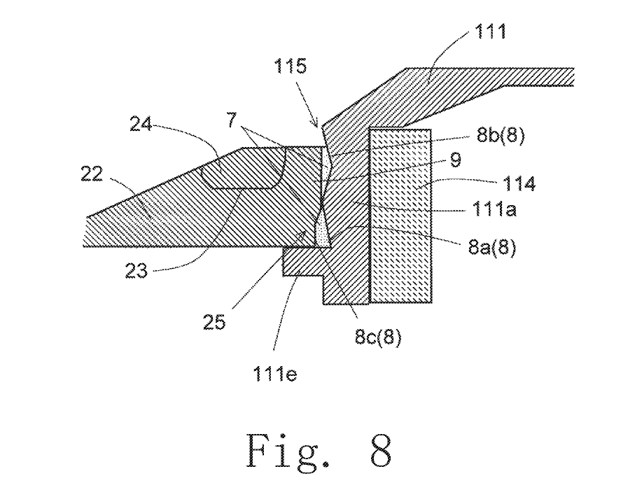

Next, the fixing structure of the impeller 2 that fixes the impeller 2 to the rotor holder 111 in the centrifugal fan 100 will be described in detail. FIG. 7 is a schematic plan view illustrating a portion of the fixing structure of the impeller 2 that fixes the impeller 2 to the rotor holder 111. FIG. 8 is a schematic sectional view taken along the line A-A in FIG. 7.

As illustrated in FIG. 7 and FIG. 8, at least a portion of the inner circumferential surface of the blade support portion 22 faces the outer circumferential surface of the rotor holder 111 in the radial direction with a gap therebetween in which an adhesive agent 7 is present at least in a portion of the gap. In detail, at least a portion of the inner circumferential surface of the blade support portion 22 faces the outer circumferential surface of the rotor cylinder portion 111a in the radial direction with a gap therebetween in which the adhesive agent 7 is present at least in a portion of the gap. In the present embodiment, a portion of the inner circumferential surface of the blade support portion 22 is in contact with the outer circumferential surface of the rotor cylinder portion 111a. This point will be touched upon later. However, the inner circumferential surface of the blade support portion 22 need not be in contact with the outer circumferential surface of the rotor cylinder portion 111a. It suffices that the adhesive agent 7 fix the blade support portion and the rotor cylinder portion 111a. For this reason, the adhesive agent 7 may be contained in the entirety of the gap provided between the inner circumferential surface of the blade support portion 22 and the outer circumferential surface of the rotor cylinder portion 111a in the radial direction or it may be contained only in a portion of the gap.

At least one of the outer circumferential surface of the rotor holder 111 and the inner circumferential surface of the blade support portion 22 has a recessed portion 8, which are recessed in the radial direction and in which the adhesive agent 7 is present. Specifically, at least one of the outer circumferential surface of the rotor cylinder portion 111a and the inner circumferential surface of the blade support portion 22 has the recessed portion 8, which are recessed in the radial direction and in which the adhesive agent 7 is present. In this embodiment, the recessed portion 8 is provided on both the outer circumferential surface of the rotor cylinder portion 111a and the inner circumferential surface of the blade support portion 22. Details of this point will be described later. The adhesive agent 7 may be contained in the entirety of the recessed portion 8 or may be contained in a portion of the recessed portion 8. By providing the recessed portion 8, for example, it is possible to absorb the influence of volume change associated with curing of the adhesive agent 7 in the recessed portion 8. Therefore, it is possible to suppress deformation of the impeller 2 and the rotor holder 111 when fixing the rotor cylinder portion 111a and the blade support portion 22 using the adhesive agent 7. In addition, because the adhesion area can be increased by providing the recessed portion 8, the impeller 2 and the rotor holder 111 can be firmly fixed. For this reason, it is possible to firmly fix the impeller 2 to the rotor holder 111 without increasing the axial-direction length of the impeller fixing portion 5.

In the present embodiment, as illustrated in FIG. 8, the outer circumferential surface of the rotor cylinder portion 111a has the recessed portion 8 overlapping at least a portion of the magnet 114 in the radial direction as a preferable configuration. In the case where the impeller 2 is press-fitted and fixed to the rotor holder 111, deformation of the rotor cylinder portion 111a may occur due to the press fitting and there is a possibility that the arrangement of the magnet 114 or the like may be affected. In the present embodiment, the impeller 2 and the rotor holder 111 are fixed by the adhesive agent 7. In such a configuration, by adopting a configuration in which the recessed portion 8 is disposed at a position overlapping the magnet 114 in the radial direction, it is possible to reduce the possibility that the influence of volume change upon curing of the adhesive agent 7 adversely affects the magnet 114. That is, according to the present embodiment, by fixing the impeller 2 to the rotor holder 111, the possibility of an adverse effect on the magnet 114 can be reduced.

As illustrated in FIG. 8, the outer circumferential surface of the rotor holder 111 has a flange portion 111e extending to the radial-direction outer side. More specifically, the outer circumferential surface of the rotor cylinder portion 111a has the flange portion 111e extending to the radial-direction outer side. Either one of the upper surface and the lower surface of the blade support portion 22 faces the flange portion 111e in the axial direction. In the present embodiment, the lower surface of the blade support portion 22 faces the flange portion 111e in the axial direction. In this configuration, the impeller 2 is fitted into the rotor holder 111 from the axial-direction upper side to lower side.

The lower surface of the blade support portion 22 may be in contact with an upper surface of the flange portion 111e. In this case, the position of the impeller 2 in the axial direction with respect to the rotor holder 111 can be set by the flange portion 111e. In addition, the adhesive agent 7 may be present at least in a portion between the lower surface of the blade support portion 22 and the upper surface of the flange portion 111e. As a result, it is possible to firmly fix the impeller 2 and the rotor holder 111.

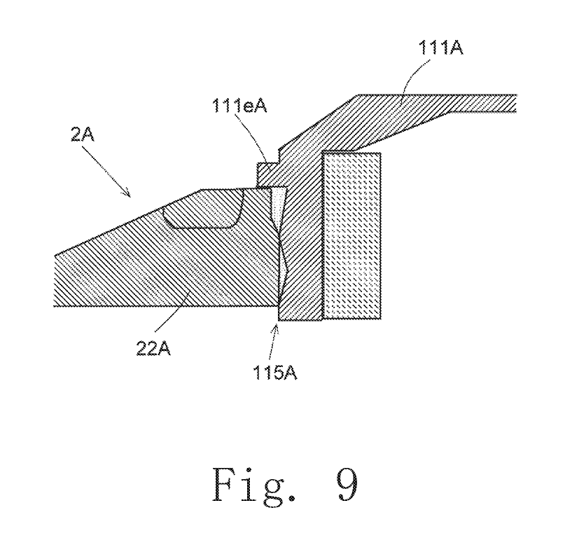

FIG. 9 is a schematic sectional view illustrating a modification example of the fixing structure of the impeller. As illustrated in FIG. 9, an upper surface of a blade support portion 22A may face a flange portion 111eA. In this configuration, an impeller 2A is fitted into a rotor holder 111A from the axial-direction lower side to upper side. Also in the configuration of the modification example, it is possible to set the position of the impeller 2A in the axial direction with respect to the rotor holder 111A. Also in the configuration of the modification example, it is possible to firmly fix the impeller 2A and the rotor holder 111A by interposing an adhesive agent on at least a portion between the impeller 2A and the rotor holder 111A in the axial direction.

Further, in the case where the rotor cylinder portion 111a is a separate member disposed on the radial-direction outer side of the rotor lid portion 111b, the inner circumferential surface of the blade support portion 22 is fixed to an outer circumferential surface of the rotor lid portion 111b or an outer circumferential surface of the rotor annular portion 111c. At this time, the impeller fixing portion 5 is formed such that the inner circumferential surface of the blade support portion 22 and the outer circumferential surface of the rotor lid portion 111b or the outer circumferential surface of the rotor annular portion 111c are fixed with an adhesive agent. Furthermore, at this time, at least one of the outer circumferential surface of the rotor lid portion 111b, the outer circumferential surface of the rotor annular portion 111c, and the inner circumferential surface of the blade support portion 22 has the recessed portion 8, which are recessed in the radial direction and in which the adhesive agent 7 is present. In addition, the outer circumferential surface of the rotor lid portion 111b or the outer circumferential surface of the rotor annular portion 111c has the flange portion 111e extending to the radial-direction outer side. Either one of the upper surface and the lower surface of the blade support portion 22 faces the flange portion 111e in the axial direction.

As illustrated in FIG. 8, the rotor holder 111 has a rotor holder irregular portion 115 in which irregularities in which the radial-direction position of the outer circumferential surface of the rotor holder 111 changes are formed at least once in the axial direction. The rotor holder 111 has the rotor holder irregular portion 115 in which irregularities in which the radial-direction position of the outer circumferential surface of the rotor cylinder portion 111a changes are formed at least once in the axial direction. In the rotor holder irregular portion 115 of the present embodiment, the irregularities in which the radial-direction position of the outer circumferential surface of the rotor cylinder portion 111a changes are formed twice in the axial direction. From top to bottom, a projection, a recess, a projection, and a recess are formed in order. The number of times the irregularities are formed may be 1 time or 3 times or more. The shapes of the recesses and the projections are not particularly limited, and may be, for example, a U shape, a V shape, or the like when viewed in cross section.

The rotor holder irregular portion 115 is provided on the same axial-direction side as the blade support portion 22 with respect to the flange portion 111e. In the present embodiment, the rotor holder irregular portion 115 is provided on the upper side of the flange portion 111e. Further, in the modification example illustrated in FIG. 9, a rotor holder irregular portion 115A is provided under the flange portion 111eA.

The rotor holder irregular portion 115 has a first recessed portion 8a facing the flange portion 111e and included in the recessed portion 8. In the present embodiment, the first recessed portion 8a is located on the upper side of the flange portion 111e. The first recessed portion 8a extends in the circumferential direction. The first recessed portion 8a may be provided all around the outer circumferential surface of the rotor cylinder portion 111a. In addition, a plurality of first recessed portions 8a may be disposed at intervals in the circumferential direction. The first recessed portion 8a overlaps the magnet 114 in the radial direction.

In a configuration in which the first recessed portion 8a is not provided, in the case where the adhesive agent 7 accumulates more than necessary at a position where a radial-direction inner end of the flange portion 111e and the outer circumferential surface of the rotor cylinder portion 111a are connected to each other, the impeller 2 becomes easily inclined with respect to the rotor holder 111. According to the configuration of the present embodiment, because the adhesive agent 7 enters the first recessed portion 8a, the inclination of the impeller 2 with respect to the rotor holder 111 can be suppressed by the impeller 2 riding over the adhesive agent 7. In addition, according to the configuration of this embodiment, it is possible to rigidly fix the impeller 2 and the rotor holder 111 by increasing the adhesion area by the first recessed portion 8a.

In a preferred embodiment, as illustrated in FIG. 8, the rotor holder irregular portion 115 further includes a second recessed portion 8b included in the recessed portion 8 at a position farther away from the flange portion 111e in the axial direction than the first recessed portion 8a. In the present embodiment, the second recessed portion 8b is located on the upper side of the first recessed portion 8a. A projection among the irregularities forming the rotor holder irregular portion 115 is present between the first recessed portion 8a and the second recessed portion 8b in the axial direction. The second recessed portion 8b extends in the circumferential direction. The second recessed portion 8b may be provided all around the outer circumferential surface of the rotor cylinder portion 111a. In addition, a plurality of second recessed portions 8b may be disposed at intervals in the circumferential direction. The second recessed portion 8b overlaps the magnet 114 in the radial direction. The adhesion area can be further increased by the second recessed portion 8b, and the impeller 2 and the rotor holder 111 can be more firmly fixed to each other.

As illustrated in FIG. 8, the blade support portion 22 has a first blade support portion irregular portion 25 in which irregularities in which the radial-direction position of the inner circumferential surface of the blade support portion 22 changes are formed at least once in the axial direction. In the first blade support portion irregular portion 25 of the present embodiment, the irregularities in which the radial-direction position of the inner circumferential surface of the blade support portion 22 changes are formed once in the axial direction. From top to bottom, a projection and a recess are formed in order. The number of times the irregularities are formed may be two or more times. The shapes of the recesses and the projections are not particularly limited, and may be, for example, a U shape, a V shape, or the like when viewed in cross section.

The first blade support portion irregular portion 25 has a third recessed portion 8c facing the flange portion 111e and included in the recessed portion 8. In the present embodiment, the third recessed portion 8c is located on the upper side of the flange portion 111e. The third recessed portion 8c extends in the circumferential direction. The third recessed portion 8c may be provided over the entire circumference of the inner circumferential surface of the blade support portion 22. In addition, a plurality of third recessed portions 8c may be disposed at intervals in the circumferential direction. By providing the third recessed portion 8c, the adhesive agent 7 can enter the third recessed portion 8c. As a result, it is possible to suppress the inclination of the blade support portion 22 riding on the adhesive agent 7. In addition, by providing the third recessed portion 8c, the adhesion area can be increased and the impeller 2 and the rotor holder 111 can be firmly fixed.

As illustrated in FIG. 7, the blade support portion 22 has a second blade support portion irregular portion 26 in which irregularities in which the radial-direction position of the inner circumferential surface of the blade support portion 22 changes are formed in the circumferential direction repeatedly. The shapes of the recesses and the projections are not particularly limited, and may be, for example, a U shape, a V shape, or the like in plan view from the axial direction. In the present embodiment, a plurality of projecting portions 9 of the second blade support portion irregular portion 26 are in contact with the outer circumferential surface of the rotor holder 111. More specifically, the plurality of projecting portions 9 of the second blade support portion irregular portion 26 are in contact with the outer circumferential surface of the rotor cylinder portion 111a. Because the plurality of projecting portions 9 come into contact with the outer circumferential surface of the rotor cylinder portion 111a, the impeller 2 can be easily arranged coaxially with respect to the rotor holder 111. In the present embodiment, an upper surface of each of the projecting portions 9 is located on the same plane as the upper surface of the blade support portion 22. On the other hand, a lower end of each of the projecting portions 9 is located on the upper side of the lower surface of the blade support portion 22. This is because the blade support portion 22 has the third recessed portion 8c. However, the third recessed portion 8c may be omitted, and the lower surface of the projecting portions 9 and the lower surface of the blade support portion 22 may be located on the same plane.

Further, it should be noted that the entirety of the projecting portions 9 need not contact the outer circumferential surface of the rotor cylinder portion 111a. The adhesive agent 7 may be interposed between the projecting portions 9 and the outer circumferential surface of the rotor cylinder portion 111a in the radial direction. The projecting portions 9 and the outer circumferential surface of the rotor cylinder portion 111a need not be in contact with each other and the adhesive agent 7 may be interposed therebetween in the radial direction over the entirety thereof. In addition, the upper surface of each of the projecting portions 9 may be located on the lower side of the upper surface of the blade support portion 22.

As illustrated in FIG. 7, it is preferable that the ribs 24 overlap the projecting portions 9 of the second blade support portion irregular portion 26 in the radial direction. According to this configuration, because the ribs 24 are provided at positions where a force is easily applied when the blade support portion 22 is attached to the rotor holder 111, deformation or the like of the blade support portion 22 at the time of assembly can be suppressed.

Further, in the above description, the blade support portion 22 is provided with the first blade support portion irregular portion 25 and the second blade support portion irregular portion 26. However, only one of the first blade support portion irregular portion 25 and the second blade support portion irregular portion 26 has to be provided. In addition, in the case where the recessed portion 8 is provided on the outer circumferential surface of the rotor cylinder portion 111a, a configuration in which neither the first blade support portion irregular portion 25 nor the second blade support portion irregular portion 26 is provided in the blade support portion 22 may be used. On the contrary, in the case where the recessed portion 8 is provided on the inner circumferential surface of the blade support portion 22, the rotor holder irregular portion 115 need not be provided.

The present invention can be applied to, for example, a centrifugal fan used for a range hood fan, a ventilating fan for a duct, a heat exchanging unit, paper suction for a printing device, facilitation of inhalation and exhaustion for a mask, and the like.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A centrifugal fan comprising:
a motor including a rotary portion that rotates about a center axis extending up and down;
an impeller fixed to the rotary portion and rotating together with the rotary portion; and
a housing that accommodates the motor and the impeller; wherein
the rotary portion includes a rotor holder in which a magnet is fixed;
the impeller includes:
a plurality of blade portions disposed at intervals in a circumferential direction; and
a blade support portion supporting the plurality of blade portions on a radial-direction outer side;
the housing includes:
an inlet port provided on an upper surface of the housing and penetrating the housing in an axial direction; and
an outlet port provided on a side surface of the housing and penetrating the housing in a radial direction;
at least a portion of an inner circumferential surface of the blade support portion faces an outer circumferential surface of the rotor holder in the radial direction with a gap therebetween in which an adhesive agent is present at least in a portion of the gap; and
at least one of the outer circumferential surface of the rotor holder and the inner circumferential surface of the blade support portion includes a recessed portion that is recessed in the radial direction and in which the adhesive agent is present.

2. The centrifugal fan according to claim 1, wherein
the outer circumferential surface of the rotor holder includes a flange portion extending to the radial-direction outer side; and
one of an upper surface and a lower surface of the blade support portion faces the flange portion in the axial direction.

3. The centrifugal fan according to claim 1, wherein
the rotor holder includes a rotor holder irregular portion in which irregularities in which a radial-direction position of the outer circumferential surface of the rotor holder changes are aligned at least once in the axial direction;
the rotor holder irregular portion is provided on an identical side in the axial direction with the blade support portion with respect to a flange portion; and
the rotor holder irregular portion faces the flange portion and includes a first recessed portion included in the recessed portion.

4. The centrifugal fan according to claim 3, wherein the rotor holder irregular portion further includes a second recessed portion included in the recessed portion at a position farther away from the flange portion in the axial direction than the first recessed portion.

5. The centrifugal fan according to claim 1, wherein an upper end of the inner circumferential surface of the blade support portion is located on a lower side of a straight line connecting a connection point of an upper surface of the blade support portion and an end portion of the blade portions on a radial-direction inner side and a radial-direction outer end of an upper end portion of the rotor holder.

6. The centrifugal fan according to claim 1, wherein
the rotor holder includes a rotor cylinder portion to which the magnet is fixed on an inner circumferential surface of the rotor cylinder portion; and
an outer circumferential surface of the rotor cylinder portion has the recessed portion overlapping at least a portion of the magnet in the radial direction.

7. The centrifugal fan according to claim 1, wherein
the blade support portion includes a first blade support portion irregular portion in which irregularities in which a radial-direction position of the inner circumferential surface of the blade support portion changes are provided at least once in the axial direction; and
the first blade support portion irregular portion faces a flange portion and includes a third recessed portion included in the recessed portion.

8. The centrifugal fan according to claim 1, wherein
the blade support portion includes a second blade support portion irregular portion in which irregularities in which a radial-direction position of the inner circumferential surface of the blade support portion changes are provided in the circumferential direction repeatedly; and
a plurality of projecting portions of the second blade support portion irregular portion are in contact with the outer circumferential surface of the rotor holder.

9. The centrifugal fan according to claim 8, wherein
the blade support portion includes an accommodating portion to accommodate a balance adjustment member;
a plurality of ribs extending in a direction including a radial direction component are disposed inside the accommodating portion; and
the plurality of ribs overlap the projecting portions in the radial direction.

10. The centrifugal fan according to claim 1, wherein
the blade support portion includes an accommodating portion to accommodate a balance adjustment member; and
the accommodating portion overlaps in the radial direction at least a portion of an impeller fixing portion in which the inner circumferential surface of the blade support portion and the outer circumferential surface of the rotor holder are fixed by the adhesive agent.

11. The centrifugal fan according to claim 9, wherein
the accommodating portion includes a groove portion that is located on an upper surface of the blade support portion and that is recessed to a lower side; and
the groove portion is located on a lower side of a straight line connecting a connection point of the upper surface of the blade support portion and an end portion of the blade portions on a radial-direction inner side and a radial-direction outer end of an upper end portion of the rotor holder.
